(19) United States
(12) Patent Application Publication
(10) Pub. No.: US 2003/0026261 A1
(43) Pub. Date: Feb. 6, 2003

(54) Method for transmission of packetized messages with emitter timeout

(76) Inventors: Ludovic Jeanne, Rennes (FR); Patrick Lopez, Livr?eacute;s/Changeon (FR); Gilles Straub, Acign?eacute; (FR)

Correspondence Address: Joseph S Tripoli, Thomson Multimedia Licensing, PO Box 5312, Princeton, NJ, 08543-0028, US

(21) Appl. No.: 10/203,468

(22) PCT Filed: Feb. 14, 2001
(86) PCT No.: PCT/EP01/01736

(30) Foreign Application Priority Data
Feb. 14, 2000 (EP) 00200476.0

(51) Int. Cl. H04L 12/56; H04J 3/16

(52) U.S. Cl. 370/394; 370/469

(57) ABSTRACT

Concerns a method for transmission of packets in a Hiperlan 2 transmitter, comprising the steps of sending packets in an automatic repeat request mode, characterized in that it further comprises the steps of: providing the data link control layer of the transmitter with a time to live parameter applicable to at least one packet received by the data link control layer from an upper layer for determining an upper transmission time for the at least one packet; checking before transmission of the at least one packet whether upper transmission time has been reached; and sending the at least one packet only when the upper transmission time has not been reached.

The invention concerns a method for transmission of packets, in particular in a Hiperlan 2 transmitter. It addresses the problem of packet discarding.

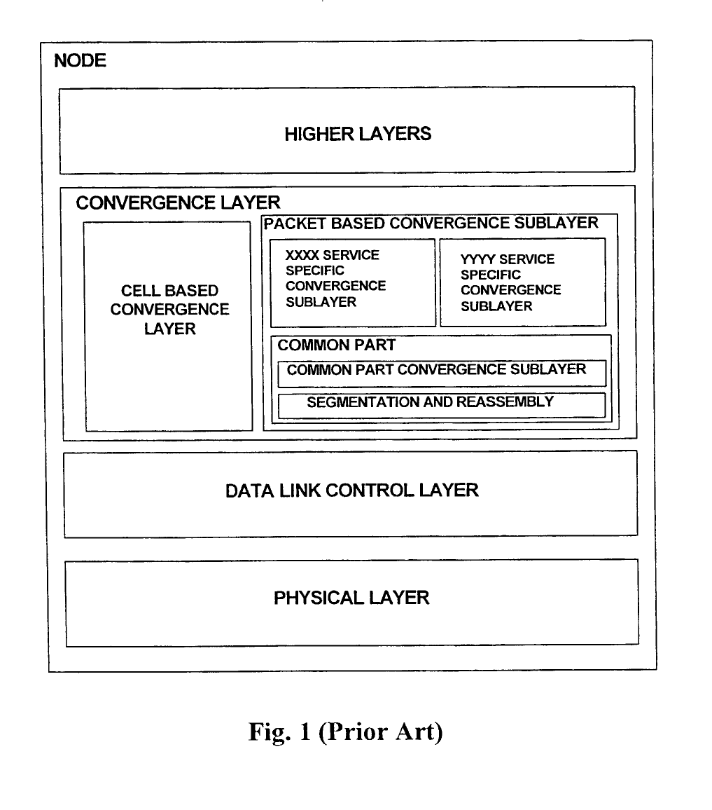

FIG. 1 represents the protocol stack of a transmitter or a receiver node in a Hiperlan 2 wireless network. From bottom to top, the stack comprises a physical layer (‘PHY’), a data link control Layer (‘DLC’), a convergence layer (‘CL’), followed by higher layers. The convergence layer CL may be of several types, in particular of the cell based type or of the packet based type. The packet based convergence layer comprises a number of service specific convergence sublayers (‘SSCS’). Examples of SSCS layers currently specified or under specification concern the Ethernet or the IEEE 1394 environment. Below this specific sublayer, a common part convergence sublayer (‘CPCS’) is included, followed by a segmentation and reassembly sublayer (‘SAR’).

The convergence layer prepares fixed-size packets (‘SAR-PDUs’) and forwards them to the data link control layer for transmission. A sequence number counter is incremented for each PDU to be transmitted. The counter's value is included into each PDU, and used by a receiver's DLC layer to restitute packets in the right order to the receiver's SAR layer.

Error control in HIPERLAN 2 allows a receiver to request the resending of incorrectly received PDUs. In this mode, the receiver acknowledges every PDU packet he receives (several packets may be acknowledged in one acknowledgement message). Negatively acknowledged PDU packets are scheduled for retransmission by the transmitter's DLC layer. A discard mechanism is defined for the DLC layer of the transmitter and the receiver, in which the transmitter informs the receiver through an appropriate message that he will not send again certain PDUs, although they have not been positively acknowledged by the receiver. The decision as to when such a discard message is to be sent is left to the implementer of the transmitter's DLC layer.

The invention concerns a mechanism at the DLC level to ensure that the transmission time can be limited to a maximum value. This would avoid using a special time-to-live field in every asynchronous 1394 packet.

The object of the invention is a method for transmission of packets in a Hiperlan 2 transmitter, comprising the steps of sending packets in an automatic repeat request mode,

characterized in that it further comprises the steps of:

providing the data link control layer of the transmitter with a time to live parameter applicable to at least one packet received by the data link control layer from an upper layer for determining an upper transmission time for the at least one packet;

checking before transmission of the at least one packet whether upper transmission time has been reached; and

sending the at least one packet only when the upper transmission time has not been reached.

HIPERLAN 2 does not define any mechanism to manage a packet maximum lifespan, which could be used by the transmitter's DLC layer to decide whether to forward a packet or whether a discard message should rather be sent to the receiver. The invention solves this problem.

There are some cases where having a knowledge of the maximum authorized transmission time may be of help to a higher layer such as an application.

For applications flowing real time data (with quality of service—or QoS—requirements), the knowledge of the maximum transmission delay allows an application to calculate the buffer size needed to compensate for transmission jitter.

In the particular case of a IEEE 1394 convergence layer, the transmission of asynchronous packets requires that the transmission time be limited to a maximum value: on a single bus the transaction layer (and even bridge switching fabrics) use the concept of a split time-out that is used to safely close a transaction when a receiver takes too long time to answer. However, this protocol assumes that the split timeout is started in both the sender and receiver sides at the same time (ack_pending packet transmission time is near instantaneous on a wired bus). In HiperLan 2 however, the transmission time is not known in advance, which makes the use of the split timeout mechanism difficult. A possible way around this problem would be to associate a time-to-live value to every asynchronous packet at the IEEE 1394 layer level so that obsolete packets could be discarded at the convergence layer level, but this additional information represents an undesirable overhead.

According to a variant embodiment, the method further comprises the step, in case of implementation of IEEE 1394 transaction layers at the transmitter and the receiver, of adding to a split timeout the time of life of both the receiver and the transmitter.

Other characteristics and advantages of the invention will appear through the description of a non-limiting embodiment, described with reference to the drawings among which:

FIG. 1, prior art, is a diagram of a HIPERLAN 2 protocol reference model;

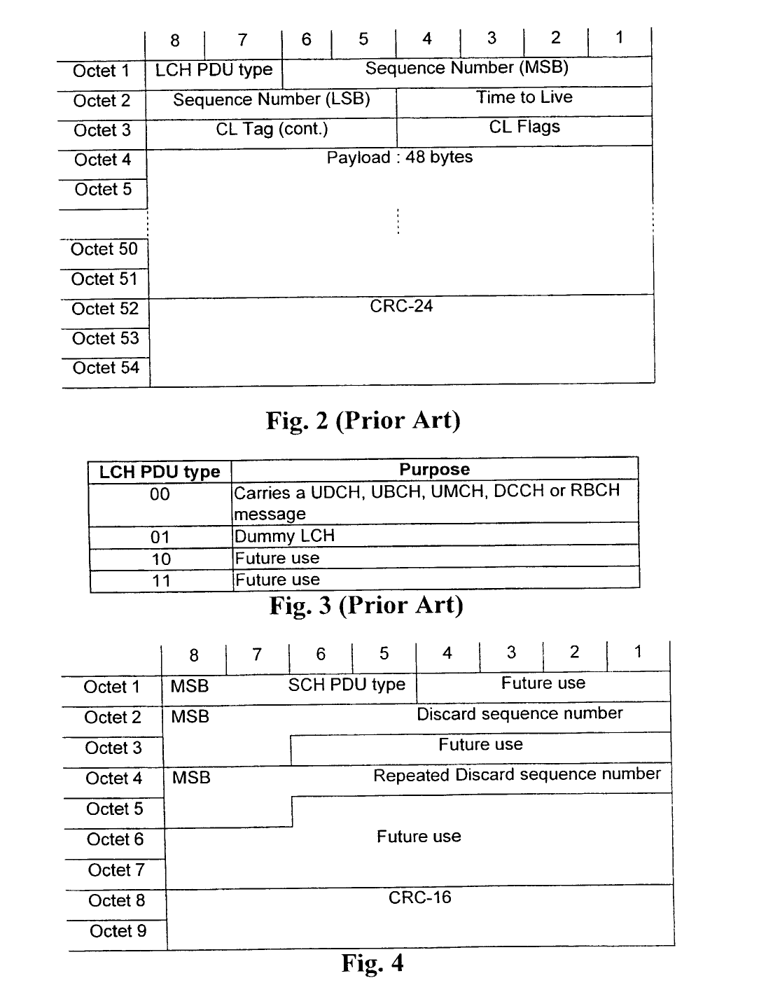

FIG. 2 is a table indicating the format of a data link control layer (DLC) PDU;

FIG. 3, prior art, is a table indicating the values of the ‘PDU Type’ parameter of the table of FIG. 2;

FIG. 4, prior art, is a table indicating the format of a ‘Discard PDU’ packet;

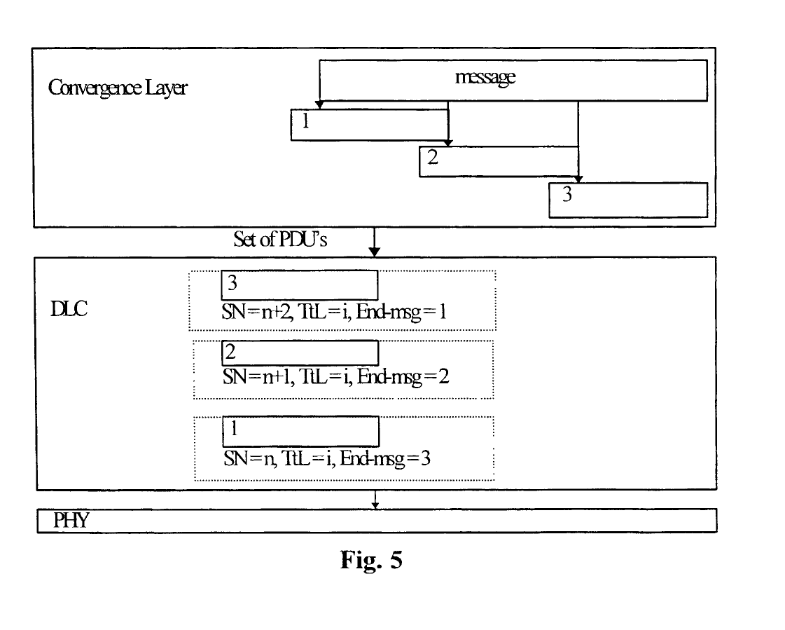

FIG. 5 is a first diagram illustrating the flow of PDUs through the convergence layer, the data link control layer and the physical layer;

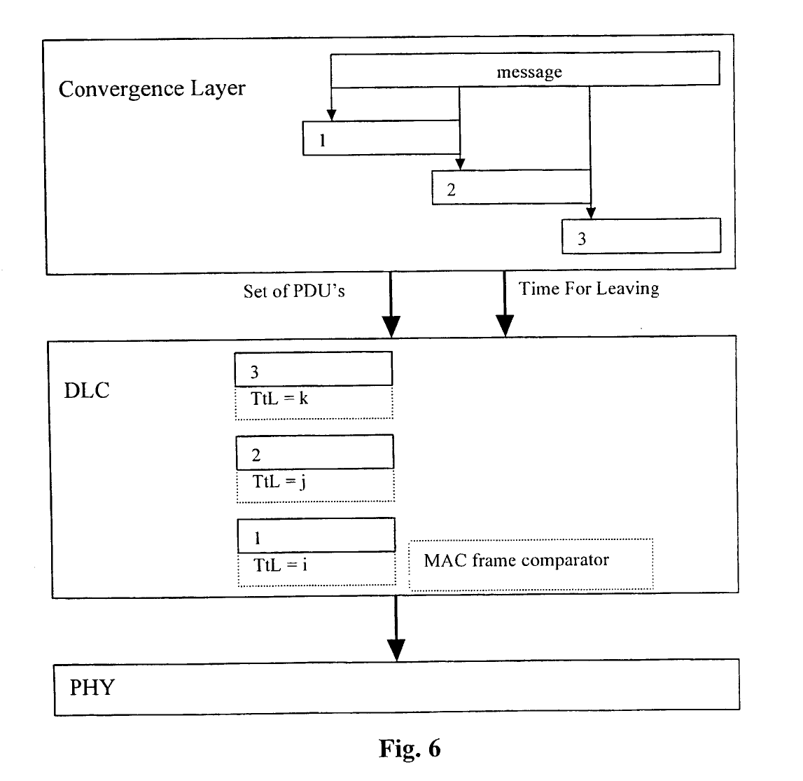

FIG. 6 is a second diagram illustrating the flow of PDUs through the convergence layer, the data link control layer and the physical layer.

This text describes the mechanism to provide a maximum transmission delay for asynchronous data in ARQ (Automatic Repeat ReQuest) mode at the DLC layer level.

More information concerning the convergence layer and the data link control layer in a HIPERLAN 2 environment can be found in the following documents:

(a) DTS/BRAN0020004-1 V0.m (1999-12) Broadband Radio Access Networks (BRAN); HIPERLAN Type 2; Data Link Control (DLC) Layer—Part 1: Basic Data Transport Function

(b) DTS/BRAN-0024004-1 V0.g (1999-11) Broadband Radio Access Networks (BRAN); HIPERLAN Type 2; Packet based Convergence Layer; Part 1: Common Part

(c) Draft TS 101 761-2 V0.g (2000-2) Broadband Radio Access Networks (BRAN) HIPERLAN Type 2; Data Link Control (DLC) layer; Part 2: Radio Link Control (RLC) Sublayer

These documents are available from ETSI.

A convergence layer (‘CL’ in what follows) receives a message from the higher layer. In the CL, this message is split over several PDUs. Each PDU has a fixed length (48 data bytes in the HYPERLAN2 standard), a header and a CRC of 24 bits. The table of FIG. 2 depicts the format of a LCH PDU, while the table of FIG. 3 gives the possible values of the ‘LCH PDU Type’ parameter, which is an indication of the PDU type.

The inventive method consists in specifying a particular Automatic Repeat Request (ARQ) mode, in which a maximum transmission time of a DLC PDU can be specified. This mode is based on the use of discard messages by the DLC layer at specific times, and can thus be described as an ‘automatic PDU discard’ ARQ mode.

This mode has thus to be known at least at the transmitter side.

(a) ARQ Mode Negotiation

According to a preferred embodiment, the ARQ mode is negotiated at the Radio Link Control (RLC) layer level. The RLC layer is part of the DLC layer, and is used for connection establishment and control purposes. It is not illustrated in FIG. 1. In order to specify whether the ARQ mode according to the invention is used or not, a specific value is given to the error correction mode (‘EC-MODE’) field of one of the DLC User Connection Set-Up PDU packets.

According to a variant embodiment, the ARQ mode is negotiated at the CL layer level, using a CL container field, and a local primitive between the CL and its local DLC.

From a layering point of view, the implementation at the RLC level is simpler, because the second approach requires a primitive from the SSCS layer to the DLC layer, over the CPCS layer. Usually, primitives are defined between adjacent layers, and do not jump over one layer. Nevertheless, both the preferred embodiment and its variant may be implemented.

Thanks to this information, the local DLC and the remote DLC of the DUC (DLC User Connection) connection are informed that the node works in the ARQ mode with “automatic discard PDU” as defined by the present description.

(b) Passing of ‘Time to Live’ Parameter Between Layers

A connection according to the specific ARQ mode has now been established.

The value of ‘time to live’ parameter which the DLC will use to make its decision on whether a PDU should be sent or discarded can be coded in several ways. This value may be absolute or relative, the latter being interesting in particular when the value is not defined by the DLC layer itself.

The time to live value may be coded as a relative MAC frame number, compared to the MAC frame number valid when the corresponding PDU packet enters the DLC layer from the CL layer.

According to the preferred embodiment, the time-to-live parameter is recorded in the CL Tag (8 bits) for each SAR or DLC PDU (see FIG. 2). This tag is currently not used in packet-based convergence layers. The DLC can then compute this time to live for every PDU. This allows to have a time to live on a connection basis (and even on a PDU basis)

According to a variant embodiment, the ‘time to live’ parameter value is determined by the chipset. In this case, the parameter value is determined by the DLC implementer. Advantageously, the SSCS layer is aware of this value so that it can calculate its split time out value accordingly.

(c) Discard Procedure in the Transmitter

The general process is the following: when the DLC layer receives a PDU from the CL layer, it determines the latest moment at which the PDU can be validly transmitted. If the DLC layer receives an absolute time to live value from the CL layer, it uses this value directly. If the DLC layer receives a relative time to live value from the CL layer, it adds this relative value to the MAC frame number valid at the time the PDU packet is received from the CL layer. If the time to live value is predetermined within the DLC layer, it also adds this value to the MAC frame number.

When a PDU is to be sent, the DLC layer checks whether the maximum sending time has expired or not. If not, it sends the PDU. If it has expired, the packet is discarded.

As an example, the PDU time to live check is carried out at the time at which the DLC is going to insert the PDU into the MAC frame.

The discard message defined by Hiperlan 2 enables to transmit to the receiver the sequence number below which no PDU will be resent. The PDUs having sequence numbers between the bottom of the reception window of the receiver and this discard sequence number (excluded) are discarded. The format of the discard PDU in Hyperlan2 is shown in FIG. 3. The ‘Discard Sequence Number’ value—which in a correctly received message is also equal to the ‘Repeated Discard Sequence Number’. For a discard PDU, the ‘SCH PDU type’ parameter is equal to “0010” (binary)

This means that all PDUs having a sequence number between the bottom of the window and the discard sequence number are discarded, although some of these PDUs may not have expired at the transmitter side.

When the time to live of a PDU packet has expired, several cases may be considered.

According to a first case, when an expired time to live is detected at the transmitter DLC, a discard message is sent to the receiver with the sequence number above the expired packet, whatever the status of previously sent packets.

According to a second case and to the preferred embodiment, when an expired PDU is detected, the transmitter waits until all PDUs with sequence numbers below that of the expired PDU have either expired or are outside of the receiver window (ok pour moi) before sending an appropriate discard message. Note that since a single discard message can be used to discard all PDUs below a certain sequence number, there is no need to send a single discard message per expired PDU.

According a variant of the preferred embodiment, when a time to live has expired, the transmitter determines all PDUs with the same time to live and thus the sequence number of the next non-expired PDU. This solution may be implemented when all PDUs of a CPCS message have the same time to live. The sequence number SN used in the discard message will then be:

max (first SN of next message, last SN of the transmitter window).

The transmitter cannot discard packets with sequence numbers outside of the transmitter window.

One possible implementation of the variant embodiment is illustrated by FIG. 5. FIG. 5 represents a message split into three PDUs as it transits through the Convergence Layer CL, the Data Link Control layer DLC and the physical layer of the emitter mobile station.

In this case, each PDU received from the CL contains a piece of data labelled ‘End-msg’ which directly indicates the number of PDUs remaining in a message. It is supposed that all PDUs of the message have the same time to live and consequently, if at least one PDU of the message expires before transmission, all following PDUs can be discarded. The ‘End-msg’ parameter is used by the DLC to determine the sequence number of the first PDU which is not to be discarded (i.e. the first PDU of the next message) and this sequence number is transmitted in the discard message. The ‘End-msg’ parameter can also be avoided by having the DLC analyze the PDU content to detect the SAR stop bit present in the header of the last PDU of a message.

FIG. 6 illustrates a variant embodiment of FIG. 4, where the time limit is transmitted by the CL to the DLC.

When the receiver receives a discard PDU without errors, it puts the bottom of its receiving windows to the value of the discard sequence number, and sends a cumulative acknowledgment to the transmitter, with a sequence number equal to or greater than the discard sequence number.

Upon reception of the cumulative acknowledgment, the transmitter puts the bottom of its transmitting windows to the value given in the acknowledgment.

Sum-up:
Without optimization, only for the first PDU of the connection

If TtL > #current MAC frame then

Send a discard message with discard SN = PDU SN + Next-msg

Else

Send the PDU.
Or with an optimization, only for the first PDU of the connection

If TtL > #current MAC frame then

Send a discard message with discard SN = max(top transmit

windows, PDU SN + Next-msg)

Else

Send the PDU.

(d) ‘Time to Live’ Parameter and Split Timeout

This section concerns the specific case of IEEE 1394 SSCS and split timeout issues related to this environment.

During the DLC connection set-up, when the ARQ mode with time to live is negotiated, the transmitter SSCS inserts into the convergence layer container an information element to describe its contribution to the overall transmission time (at least it shall indicate what is its own time to live). Then, when the DLC connection is established, each node can calculate the overall time to live (i.e. the sum of both transmitters' Time to live). This overall time to live shall be indicated to the upper layer (either a Transaction layer, or a bridge layer), so that the split time out is adjusted.

A Transaction layer uses a split time out value which is negotiated between 1394 applications (using standard control and status register ‘CSR’ read and write commands). The split timeout of a node is accessible in a CSR register, as defined by IEEE 1394-1995. It is started on the originating side when an acknowledgment pending message (‘ack_pending’) is received, following a transaction request. It is started on the destination side when the ack_pending is generated. When the split timeout expires on the destination side, the node stops sending responses. When it expires on the originating side, it indicates that the transaction is aborted and the node can then safely recycle transaction labels. In the case of the present embodiment, i.e. in the case of a HIPERLAN2 transmission, the real split time out the transaction layer uses (to stop sending responses, or to recycle transaction labels) shall be the CSR register which is reflected in the split timeout CSR register (1394-1995) to which the overall time to live over HL2 has been added.

This ensures correct handling of an IEEE 1394 transaction layer over a HL2 1394 SSCS.

1. Method for transmission of packets in a Hiperlan 2 transmitter, comprising the steps of sending packets in an automatic repeat request mode,
characterized in that it further comprises the steps of:
providing the data link control layer of the transmitter with a time to live parameter applicable to at least one packet received by the data link control layer from an upper layer for determining an upper transmission time for the at least one packet;
checking before transmission of the at least one packet whether upper transmission time has been reached; and
sending the at least one packet only when the upper transmission time has not been reached.

2. Method according to claim 1, further comprising one of the step, for a transmitter, of negotiating with a receiver the use of an automatic repeat request mode comprising the upper transmission time check at the transmitter side,
(a) at the radio link control layer level, during set-up of a connection between the transmitter and the receiver, or
(b) at the convergence layer level, indicating said mode in a convergence layer container field.

3. Method according to one of the steps 1 or 2, wherein said time to live parameter for each packet is indicated to the data link control layer in each packet received from the convergence layer.

4. Method according to one of the steps 1 to 2, wherein the time to live is predetermined in the data link control layer.

5. Method according to one of the claims 1 to 4, further comprising the step, in case a packet is not transmitted before the upper transmission time, of notifying the receiver of the aborted transmission through a discard message.

6. Method according to claim 5, wherein a discard message for a packet is sent only when the following condition is met: all packets with a sequence number lower than that of the packet having an expired upper transmission time also have an expired upper transmission limit;

7. Method according to one of the claims 5 or 6, wherein a discard message is sent only if the packet for which the upper transmission limit has expired is the first packet of a connection.

8. Method according to one of the claims 1 to 6, further comprising the step, in case of implementation of IEEE 1394 transaction layers at the transmitter and the receiver, of adding to a split timeout the time of life of both the receiver and the transmitter.
